(19) United States
(12) Patent Application Publication
(10) Pub. No.: US 2018/0200882 A1
(43) Pub. Date: Jul. 19, 2018

(54) SERVOMOTOR CONTROL DEVICE, SERVOMOTOR CONTROL METHOD, AND COMPUTER READABLE RECORDING MEDIUM

(71) Applicant: FANUC CORPORATION, Minamitsuru-gun (JP)

(72) Inventors: Shougo SHINODA, Yamanashi (JP); Satoshi IKAI, Yamanashi (JP)

(21) Appl. No.: 15/862,166

(22) Filed: Jan. 4, 2018

(30) Foreign Application Priority Data
Jan. 13, 2017 (JP) 2017-004166

(51) Int. Cl. B25J 9/10; G05B 19/404; B25J 3/04; B25J 9/16

(52) U.S. Cl. CPC B25J 9/1085; G05B 19/404; G05B 2219/41138; B25J 9/1633; B25J 3/04

(57) ABSTRACT

A servomotor control device includes: a driven body configured to be driven by a servomotor; a connection mechanism configured to connect the servomotor and the driven body; a position command generation unit configured to generate a position command value for the driven body; a motor control unit configured to control the servomotor using the position command value; a force estimation part configured to estimate a force estimated value which is a drive force acting on the driven body at a connecting part with the connection mechanism; and a compensation amount generation part configured to generate a compensation amount for compensation the position command value generated by the position command generation part, using a product of the force estimated value and a coefficient indicating a physical constant, in which the coefficient indicating the physical constant changes by the force estimated value or a magnitude of the compensation amount thus generated.

This application is based on and claims the benefit of priority from Japanese Patent Application No. 2017-004166, filed on 13 Jan. 2017, the content of which is incorporated herein by reference.

### BACKGROUND OF THE INVENTION

### Field of the Invention

The present invention relates to a servomotor control device having a function of compensating the position of a driven body that is driven by the power of a servomotor, a servomotor control method, and a computer readable recording medium.

### Related Art

Conventionally, there are servomotor control devices that mount a workpiece (work) on a table, and cause the table to move via a connection mechanism by a servomotor. The table and workpiece are driven bodies. The connection mechanism has a coupling which is connected to the servomotor, and a ball screw which is fixed to the coupling. The ball screw is threaded to a nut. Among such servomotor control devices, there is a servomotor control device having a function of compensating the position of the driven body (also referred to as mobile body) that is driven by the power of the servomotor.

For example, in Patent Document 1, there is a description of a servomotor control device in which a force estimation unit estimates the drive force acting on the driven body at a connecting part of the connection mechanism, and a compensation unit compensates a position command value based on the estimated drive force. In Patent Document 2, there is a description of a servomotor control device in which a position compensation mount calculation unit calculates the stretch/contraction amount of the ball screw from a distance from the servomotor to the mobile body, and the torque command value, calculates a position compensation amount for the mobile body threaded to the ball screw from this stretch/contraction amount, and compensates the position command value according to this position compensation amount. In addition, in Patent Document 3, there is a description of a servomotor control device in which a stretch/contraction amount calculation unit of the servomotor control device calculates a stretch/contraction amount of a ball screw based on a tension acting on a distal side of the ball screw from the servomotor, a distance between a pair of fixing parts supporting the ball screw at both ends, a distance from the fixing part provided at a proximal side of the servomotor until a movable body, and a torque command given to the servomotor, and a position compensation amount calculation unit calculates a position compensation amount for a feed shaft based on the calculated stretch/contraction amount of the ball screw.
Patent Document 1: Japanese Unexamined Patent Application, Publication No. 2014-109785
Patent Document 2: Japanese Unexamined Patent Application, Publication No. 2014-13554
Patent Document 3: Japanese Unexamined Patent Application, Publication No. 2014-87880

### SUMMARY OF THE INVENTION

The present inventors have found that, in the case of compensating the position command value, during stop or low-speed operation, a compensation reacting to the drive force estimated and unrelated to the mechanical operation is applied to the position command value, whereby oscillation of the compensation amount arises. The present invention has an object of providing a servomotor control device for a machine tool or industrial machine capable of position control of a driven body with higher precision, a servomotor control method, and a computer readable recording medium.

A servomotor control device according to a first aspect of the present invention is a servomotor control device including: a servomotor (e.g., the servomotor 50 described later);
a driven body (e.g., the table 70 described later) configured to be driven by the servomotor;
a connection mechanism (e.g., the connection mechanism 60 described later) configured to connect the servomotor and the driven body to transfer power of the servomotor to the driven body;
a position command generation unit (e.g., the position command generation unit 10 described later) configured to generate a position command value for the driven body;
a motor control unit (e.g., the motor control unit 20 described later) configured to control the servomotor using the position command value;
a force estimation unit (e.g., the force estimation part 302 described later) configured to estimate a force estimated value which is drive force acting on the driven body at a connecting part with the connection mechanism;
a compensation amount generation part (e.g., the compensation amount generation part 301 described later) configured to generate a compensation amount for compensating the position command value generated by the position command generation unit, using a product of the force estimated value and a coefficient indicating a physical constant; and
a coefficient setting unit (e.g., the torsion constant setting part 307 described later) configured to change the coefficient indicating the physical constant by the force estimated value or a magnitude of the compensation amount generated.

According to a second aspect of the present invention, in the servomotor control device as described in the first aspect,
the compensation amount generation part may set, as the compensation amount, the sum of a product of the force estimated value and a first coefficient, and a product of the force estimated value, distance from the servomotor until the connecting part and a second coefficient, and
the product of the force estimated value and the first coefficient may be a product of the force estimated value and a coefficient indicating a physical constant.

According to a third aspect of the present invention, in the servomotor control device as described in the first or second aspect, it may be configured so that the coefficient indicating the physical constant is continuously or discretely made smaller based on the force estimated value estimated by the force estimation unit, upon an absolute value for the force estimated value becoming large than a predetermined value.

According to a fourth aspect of the present invention, in the servomotor control device as described in the first or second aspect, it may be configured so that the coefficient indicating the physical constant is continuously or discretely made smaller based on the compensation amount generated by the compensation amount generation part, upon an absolute value for the compensation amount that was generated becoming greater than a predetermined value.

A servomotor control method for a servomotor control device according to a fifth aspect of the present invention is a servomotor control method for a servomotor control device including: a servomotor (e.g., the servomotor 50 described later);
a driven body (e.g., the table 70 described later) configured to be driven by the servomotor; and
a connection mechanism (e.g., the connection mechanism 60 described later) configured to connect the servomotor and the driven body to transfer power of the servomotor to the driven body,
the method including the steps of:
generating a position command value for the driven body;
estimating a force estimated value which is a drive force acting on the driven body at a connecting part with the connection mechanism;
compensating the position command value by a compensation amount generated using a product of the force estimated value thus estimated and a coefficient indicating a physical constant; and
controlling the servomotor using the position command value thus compensated,
in which the coefficient indicating the physical constant changes by the force estimated value or a magnitude of the compensation amount thus generated.

According to a sixth aspect of the present invention, in the servomotor control method as described in the fifth aspect, the compensation value for compensating the position command value may be the sum of a product of the force estimated value and a first coefficient, and a product of the force estimated value, distance from the servomotor until the connecting part, and a second coefficient, and the product of the force estimated value and first coefficient may be a product of the force estimated value and a coefficient indicating a physical constant.

According to a seventh aspect of the present invention, in the servomotor control method as described in the fifth or sixth aspect, it may be configured so that the coefficient indicating the physical constant is continuously or discretely made smaller based on the estimated value thus estimated, upon an absolute value for the force estimated value becoming greater than a predetermined value.

According to an eighth aspect of the present invention, in the servomotor control method as described in the fifth or sixth aspect, it may be configured so that the coefficient indicating the physical constant is continuously or discretely made smaller based on the compensation amount thus generated, upon an absolute value for the compensation amount thus generated becoming greater than a predetermined value.

A non-transitory computer readable recording medium according to a ninth aspect of the present invention is a non-transitory computer readable recording medium encoded with a program for servomotor control that causes a computer to execute servomotor control of a servomotor control device including:
a servomotor (e.g., the servomotor 50 described later);
a driven body (e.g., the table 70 described later) configured to be driven by the servomotor; and
a connection mechanism (e.g., the connection mechanism 60 described later) configured to connect the servomotor and the driven body to transfer power of the servomotor to the driven body, the program causing the computer to execute processing of:
generating a position command value for the driven body;
estimating a force estimated value that is a drive force acting on the driven body at a connecting part with the connection mechanism;
compensating the position command value with a compensation amount generated using a product of the force estimated value thus estimated and a coefficient indicating a physical constant; and
controlling the servomotor using the position command value thus compensated,
in which the coefficient indicating the physical constant changes by the force estimated value or magnitude of the compensation amount thus generated.

According to the present invention, position control of a driven body with higher precision becomes possible that suppresses oscillation of a compensation amount arising by a compensation reacting to the drive force estimated and unrelated to mechanical operation from being applied to a position command value.

### BRIEF DESCRIPTION OF THE DRAWINGS

FIG. 1 is a block diagram showing the configuration of a servomotor control device serving as a technical premise;

FIG. 2 is a drawing for explaining oscillation of a compensation amount;

FIG. 3 is a characteristic diagram of load torque and elastic deformation amount in a case of the characteristic of the machine being in a linear relationship;

FIG. 4 is a characteristic diagram of load torque and elastic deformation amount in a case of the characteristic of the machine being in a non-linear relationship;

FIG. 5 is a block diagram showing the configuration of a servomotor control device according to a first embodiment of the present invention;

FIG. 6 is a block diagram showing the configuration of a servomotor control device according to a comparative example;

FIG. 7 is a characteristic diagram for explaining the problem in a case of performing compensation with the characteristic of the machine as a linear characteristic in a region becoming non-linear;

FIG. 8 is a characteristic diagram for explaining a case of causing a compensation coefficient (slope) to vary in response to the value of estimated load torque;

FIG. 9 is a characteristic diagram of a case of establishing the curve showing the relationship between the compensation amount and estimated load torque as a quadratic curve (parabola) contacting at a point A with a straight line passing through the origin and point A;

FIG. 10 is a characteristic diagram of a case of establishing a curve showing the relationship between the compensation amount and estimated load torque as a curve contacting at a point A with a straight line passing through the origin and point A, and contacting at a point B with a straight line C;

FIG. 11 is a block diagram showing one configuration example of a motor control unit and the configuration of a servomotor control device including a distance calculation part that obtains the length of a ball screw (length of spring element);

FIG. 12 is a block diagram showing one configuration example of a speed command creation part;

FIG. 13 is a block diagram showing one configuration example of a torque command creation part;

FIG. 14 is a flowchart showing operation of the servomotor control device shown in FIG. 5;

FIG. 15 is a block diagram showing the configuration of a servomotor control device serving as a second embodiment of the present invention; and

FIG. 16 is a characteristic diagram for explaining a case of causing a compensation coefficient (slope) to vary in response to the value of a compensation amount.

### DETAILED DESCRIPTION OF THE INVENTION

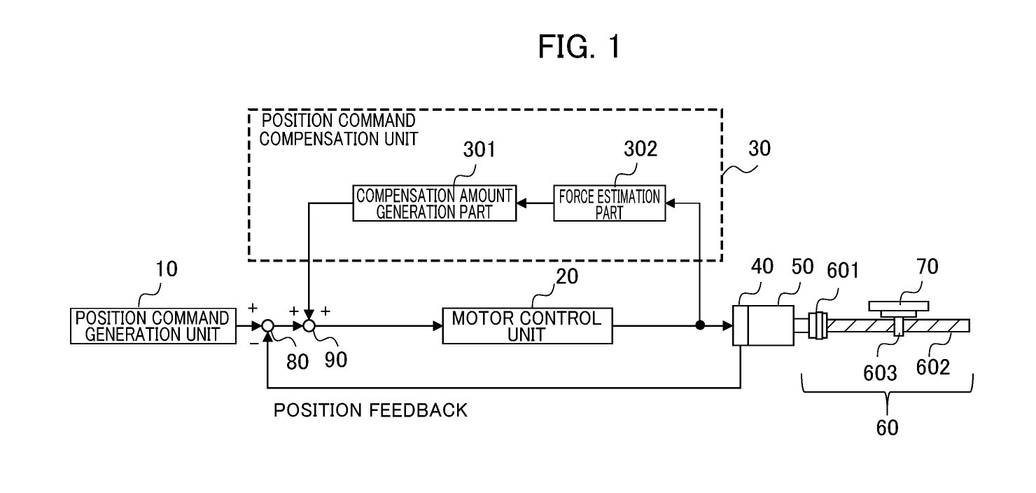

Hereinafter, an embodiment of the present invention will be explained using the drawings. First, a servomotor control device serving as a technical premise will be explained prior to the explanation of the embodiment of the present invention. FIG. 1 is a block diagram showing the configuration of a servomotor control device serving as the technical premise. The servomotor control device causes the table 70 to move via the connection mechanism 60 by way of the servomotor 50, and machines the workpiece (work) mounted on the table 70. The connection mechanism 60 has a coupling 601 connected to the servomotor 50 and a ball screw 602 that is fixed to the coupling 601, in which a nut 603 is threaded to the ball screw 602. By way of rotational driving of the servomotor 50, the nut 603 threaded with the ball screw 602 moves in the axial direction of the ball screw 602.

The rotation angle position of the servomotor 50 is detected by an encoder 40 associated with the servomotor 50 and serving as a position detection unit, and the detected position (position detected value) is used as a position feedback. It should be noted that the encoder 40 is capable of detecting the rotational speed, and the detected speed (speed detected value) can be used as a speed feedback. The servomotor control device has a position command generation unit 10 that creates a position command value for the servomotor 50 following a program and/or command inputted from a higher-order control device, external input device, etc. which is not illustrated, a subtracter 80 for obtaining a difference between the position command value created by the position command generation unit 10 and the position detection value detected by the encoder 40, an adder 90 that adds this difference and the compensation value outputted from the position command compensation unit 30, and a motor control unit 20 that creates a torque command value for the servomotor 50 using this addition value.

During driving of the servomotor 50, the drive force acts on the connection mechanism 60 and table 70, whereby the connection mechanism 60 and table 70 elastically deform. Since the connection mechanism 60 has low rigidity compared to the table 70 serving as a driven body, the elastic deformation of the connection mechanism 60 accounts for the majority of the overall elastic deformation. When the connection mechanism 60 elastically deforms, even in a case of the servomotor 50 rotating according to the command value, error in the amount of the elastic deformation amount arises in the position of the table 70. For this reason, in order to eliminate this error, the position command value is compensated by the amount of the elastic deformation amount of the connection mechanism 60. The elastic deformation amount of the connection mechanism 60 is proportional to the drive force acting on the table 70 at the nut 603 serving as the connecting part between the table 70 and the connection mechanism 60, and the drive force can be expressed by the drive torque acting on the connecting part. The position command compensation unit 30 has a compensation amount generation part 301 and force estimation part 302. The force estimation part 302 estimates the drive force (drive torque) acting on a driven body at the connecting part using the torque command value. The compensation amount generation part 301 generates a compensation amount for compensating the position command value generated by the position command generation unit 10 based on the drive force estimated by the force estimation part 302, and outputs this compensation amount as the compensation value.

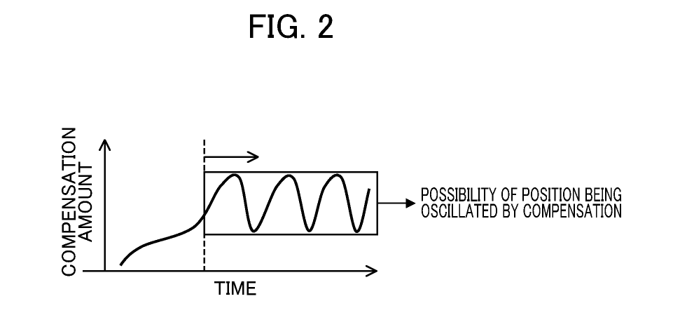

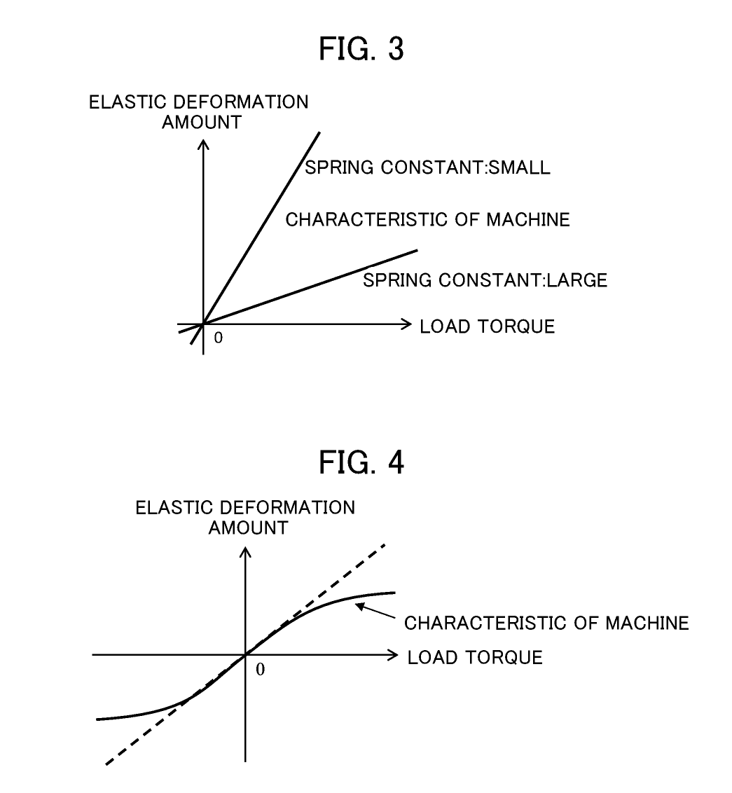

The present inventors have found that, in the servomotor control device which is the technical premise shown in FIG. 1, even during stop or low-speed operation, there is a case where compensation reacting to the drive force estimated and unrelated to the mechanical operation is applied to the position command value, and oscillation of the compensation amount occurs as shown in FIG. 2. The present inventors have considered that the above-mentioned oscillation in compensation amount arises by the compensation amount calculated from the set parameters greatly differing (too great or too small) relative to the actual elastic deformation amount to be compensated. The elastic deformation amount of the ball screw in the servomotor control device is decided by the magnitude of the spring constant (rigidity) of the ball screw. As shown in FIG. 3, if the spring constant is large, the deformation amount relative to the change in load torque is small, and oppositely, if the spring constant is small, the deformation amount relative to the change in load torque becomes larger.

In FIG. 3, although representing the characteristic of the machine by a straight line (load torque and elastic deformation amount is linear relationship), in practice, the characteristic of elastic deformation of the ball screw depends on the characteristic of the metal relative to friction of the ball screw, or twisting in the rotational axis direction, and thus the characteristic of the machine becomes a non-linear characteristic as shown in FIG. 4. The present inventors have found that oscillation of the compensation amount can be suppressed by performing compensation reflecting the intrinsic characteristic of the machine (non-linearity), in which the load torque and elastic deformation amount are non-linear. More specifically, the present inventors have found that the oscillation of the compensation amount can be suppressed by varying the coefficient indicating the physical constant for calculating the compensation value in the compensation amount generation part, based on the drive force (drive torque) estimated by the force estimated value or compensation amount generated by the compensation amount generation part.

Hereinafter, an embodiment of the servomotor control device of the present invention suppressing oscillation of the compensation amount will be explained. The machine to which the servomotor control device of the present embodiment explained below is a machine tool such as a laser beam machine, electrical discharge machine or cutting machine; however, the servomotor control device of the present invention is applicable to industrial machinery, etc. such as robots.

### First Embodiment

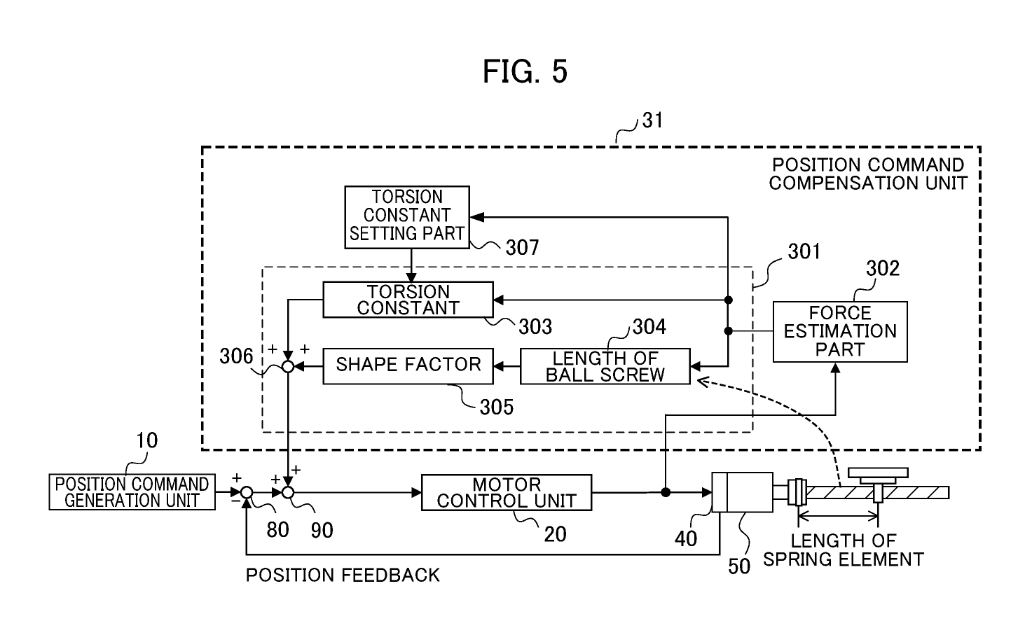

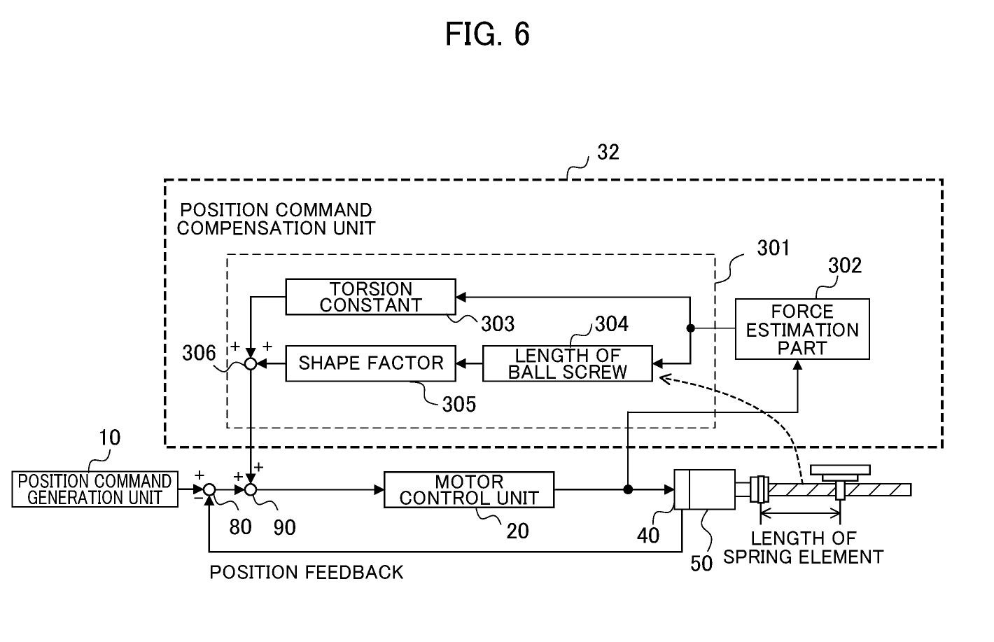

FIG. 5 is a block diagram showing the configuration of a servomotor control device serving as a first embodiment of the present invention. FIG. 6 is a block diagram showing the configuration of a servomotor control device serving as a comparative example. In FIGS. 5 and 6, the same reference symbols are attached to constituent elements that are identical to constituent elements of the servomotor control device in FIG. 1, and explanations thereof will be omitted. The position command compensation unit 30 shown in FIG. 1 is replaced by the position command compensation unit 31 in the embodiment shown in FIG. 5, and is replaced by the position command compensation unit 32 in the comparative example shown in FIG. 6. In the comparative example shown in FIG. 6, a torsion constant multiplying part 303, ball screw length multiplying part 304, shape factor multiplying part 305 and adder 306 are provided as the compensation amount generation part 301 shown in FIG. 1. In the embodiment shown in FIG. 5, the torsion constant multiplying part 303, ball screw length multiplying part 304, shape factor multiplying part 305 and adder 306 are provided as the compensation amount generation part 301 shown in FIG. 1, as well as a torsion constant setting part 307 serving as a constant setting part being provided outside of the compensation amount generation part 301. The shape factor indicates the stretch/contraction amount per unit of the ball screw. As already explained, the force estimation part 302 estimates and outputs the drive force (drive torque) acting of the driven body at the connecting part using the torque command value outputted from the motor control unit 20. This estimated value of load torque is the force estimated value. It should be noted that the estimation of the drive force is not limited thereto, and the force estimation part may estimate the drive force by further adding acceleration/deceleration torque, disturbance torque, etc., or may estimate the drive force by calculating the motor torque using the output of an electric current detection part detecting the motor current, rather than the torque command value.

With the configurations of FIG. 5 and FIG. 6, the compensation mount generation part 301 calculates the torsional elastic deformation around the rotation axis and the stretch/contraction elastic deformation in the axial direction occurring in the connection mechanism (coupling and ball screw), based on the load torque estimated by the force estimation part 302, and compensates the lost motion caused by elastic deformation in the position command value. The input of the ball screw length multiplying part 304 is the force estimated value; therefore, the position compensation amount has a dependency on the length of the ball screw. At this time, the elastic deformation in the axial direction depends on the distance from the servomotor until the driven body, and this distance is estimated according to the integrated value of the movement position.

When expressing the estimated load torque as T, and the torsion constant (constant indicating a physical constant) as α, the compensation amount related to the twist of the connecting part is expressed by α×T. When expression the estimated load torque as T, the length of the ball screw as d, and the shape factor as β, the compensation amount related to the stretch contraction of the ball screw is expressed by d×β×T. Then, the compensation amount which is the total produced by adding these compensation amounts by the adder 306 is expressed by α×T+d×β×T. In the comparative example shown in FIG. 6, since the torsion constant for calculation of the compensation amount in the torsion constant multiplying part 303 is set as a fixed value, a difference arises between the actual characteristic of elastic deformation and the compensation amount. More specifically, in the comparative example, although the coefficient of the ball screw for calculating the compensation amount (1/spring constant) is given by a fixed value, the spring constant of the ball screw is intrinsically not a fixed value, and is a variable that depends on the load torque; therefore, a difference arises between the actual characteristic of elastic deformation and the compensation amount. The coefficient (1/spring constant) is equal to the coefficient (elastic deformation amount/force).

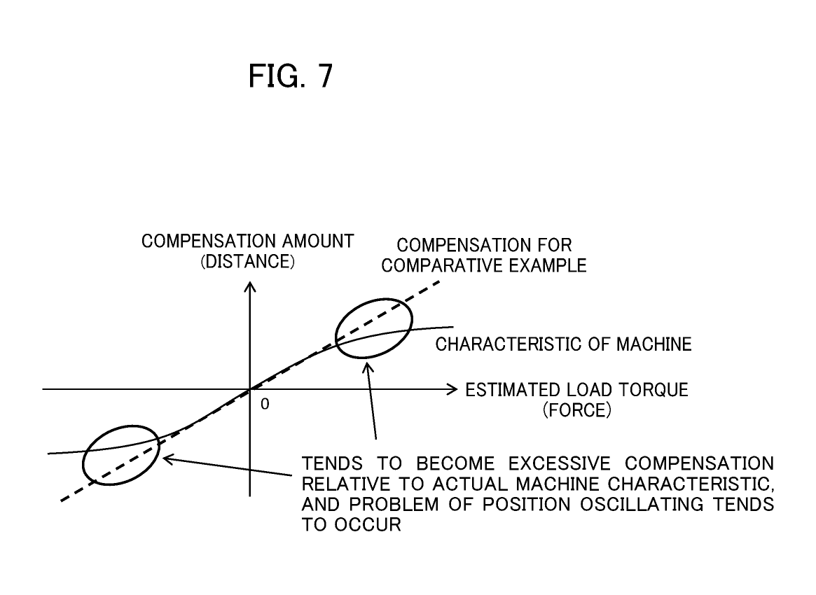

As shown in FIG. 7, in the case of the characteristic of the machine becoming a non-linear characteristic, if compensation is performed with the characteristic of the machine being a linear characteristic as in the comparative example in a region that is non-linear, excessive compensation tends to be performed on the actual mechanical characteristic, and a problem tends to occur in that oscillation of the compensation amount such as that shown in FIG. 2 arises. With the servomotor control device of the present embodiment shown in FIG. 5, in order to prevent the problem of oscillation in the compensation amount arising and the motor position wandering, the torsion constant setting part 307 changes the coefficient (elastic deformation amount/force estimated value) for calculating the compensation amount according to the value of the load drive force (torque) estimated in the force estimation part 302.

The torsion constant setting part 307 changes the coefficient of the torsion constant multiplying part 303 according to the load drive force (torque), whereby it is possible to perform compensation reflecting the characteristic of the machine having non-linearity.

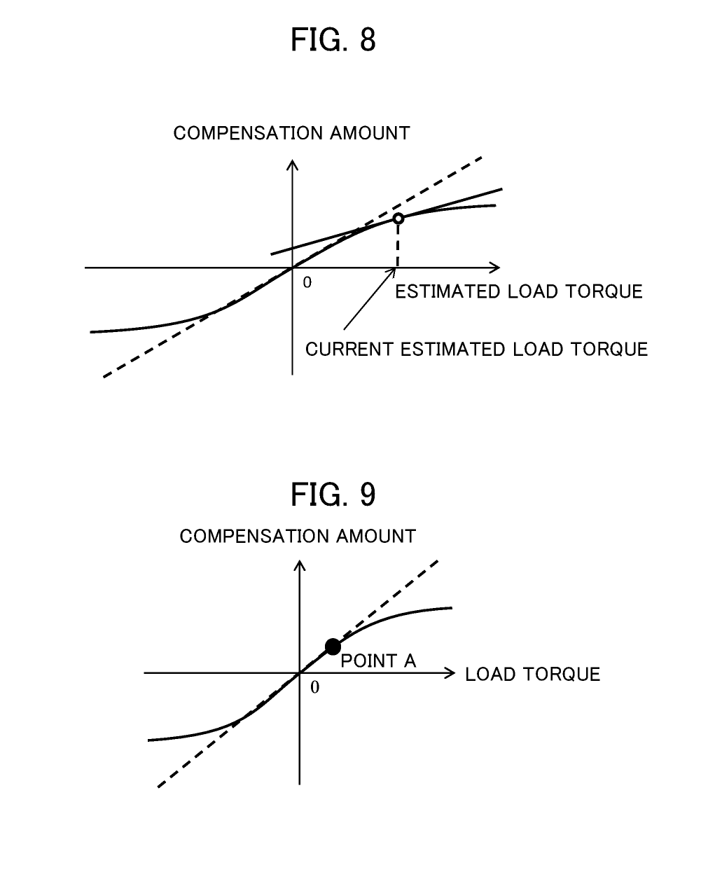

As shown in FIG. 8, if the change amount for the coefficient of the compensation amount related to the estimated load torque is decided in advance, since the estimated load torque and compensation amount correspond one-to-one, it is possible to vary the coefficient (slope) of the compensation amount according to the current value for the estimated load torque. The coefficient for the compensation amount is greater than 0 (slope is positive).

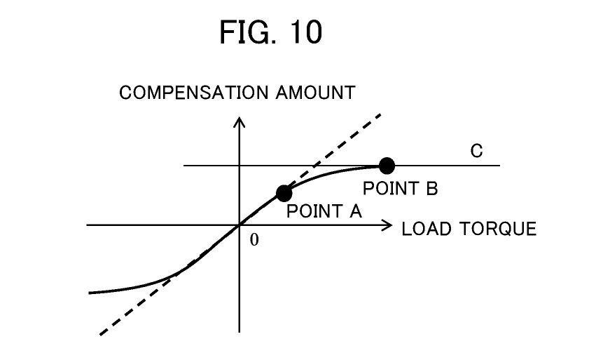

As shown in FIG. 9, the curve indicating the relationship between the compensation amount and estimated load torque may be a quadratic curve (parabola) contacting at a point A set in advance by parameters, etc. with a straight line passing through the origin and point A. In addition, as shown in FIG. 10, the curve indicating the relationship between the compensation amount and the estimated load torque may be a curve contacting at the point A set in advance by parameters, etc. with a straight line passing through the origin and the point A, and contacting at a point B set in advance by parameters, etc. with a straight line C set in advance by parameters, etc. As shown in FIG. 9 and FIG. 10, upon the absolute value for the estimated load torque (force estimated value) becoming greater than a predetermined value (upon becoming greater than point A), the compensation amount is continuously made smaller based on the estimated load torque. The compensation amount may be decreased not continuously, but rather discretely.

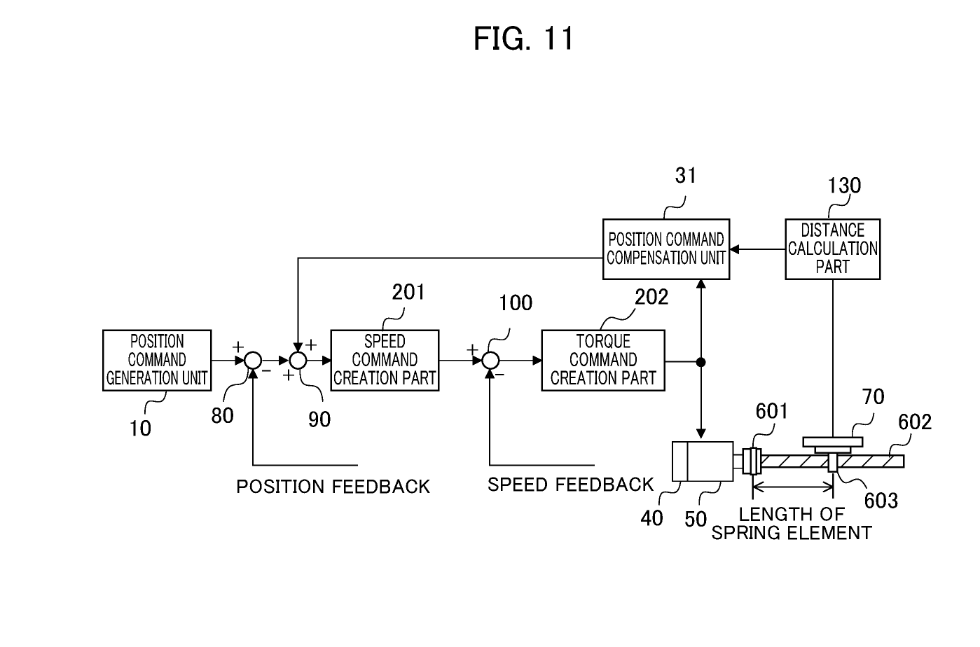

FIG. 11 is a block diagram showing one configuration example of the motor control unit 20 and the configuration of the servomotor control device including the distance calculation part 130 which obtains the length of the ball screw (length of spring element). The length of the ball screw (length of spring element) multiplied by the ball screw length multiplying part 304 in FIG. 5 is calculated by the distance calculation part 130. The motor control unit 20 in FIG. 5 has a speed command creation part 201, subtraction part, and torque command creation part 202.

Calculation of the compensation amount is (compensation amount)={(shape factor×ball screw length)+torsion coefficient}×(estimated load torque). The length d of the ball screw is the length of the ball screw from the servomotor until the connection mechanism, and changes according to the position on the table.

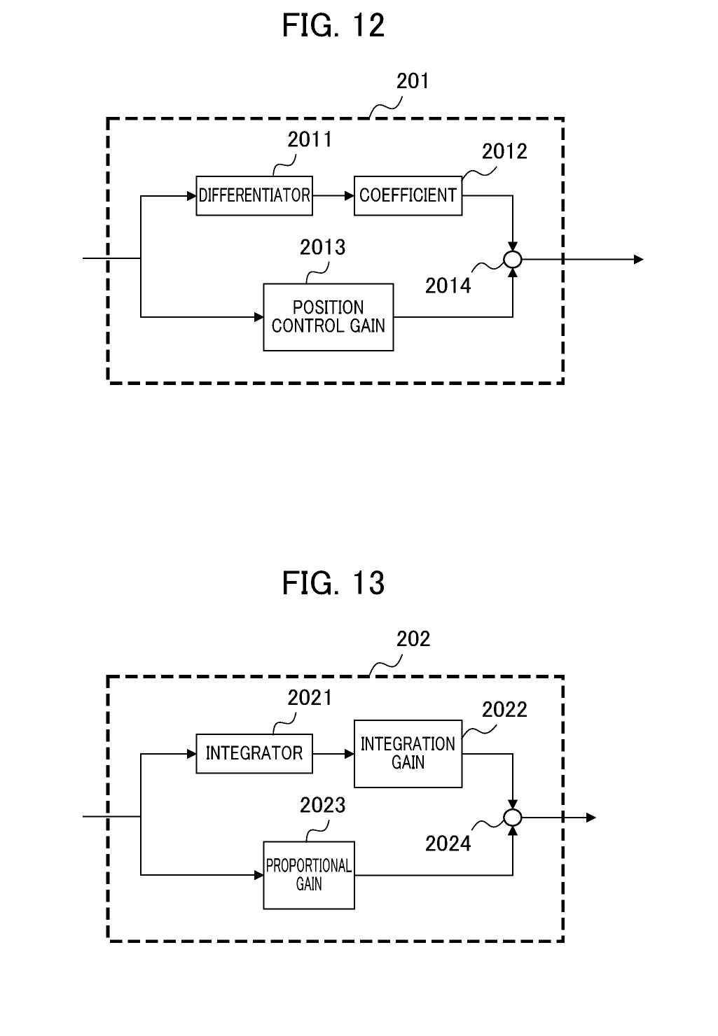

FIG. 12 is a block diagram showing one configuration example of a speed command creation part 201. The position command generation unit 10 creates the position command value, the subtracter 80 obtains the difference between the position command value and the detected position of position feedback, and the adder 90 adds the compensation amount to this difference. The difference to which the compensation amount was added is inputted to a differentiator 2011 and position control gain 2013 shown in FIG. 12. The adder 2014 adds of the output of a coefficient part 2012 made by multiplying a coefficient by the output of the differentiator 2011, and the output of the position control gain 2013, and outputs this addition value as a speed command value. The difference between the speed command value and the detected speed of speed feedback is obtained by the subtracter 100.

FIG. 13 is a block diagram showing one configuration example of the torque command creation part 202. The torque command creation part 202 includes a proportional gain 2023 and integrator 2021 connected with the subtracter 100, an integration gain 2022 connected with the integrator 2021, and an adder 2024 that adds the output of the proportional gain 2023 and the output of the integration gain 2022, and outputs to the servomotor 50 as the torque command. The integrator 2021 integrates the input. The integration gain 2022 multiplies a coefficient by the output of the integrator 2021, and the proportional gain 2023 multiplies a coefficient by the input. It should be noted that the integration gain 2022 and integrator 2021 may be changed in arrangement sequence.

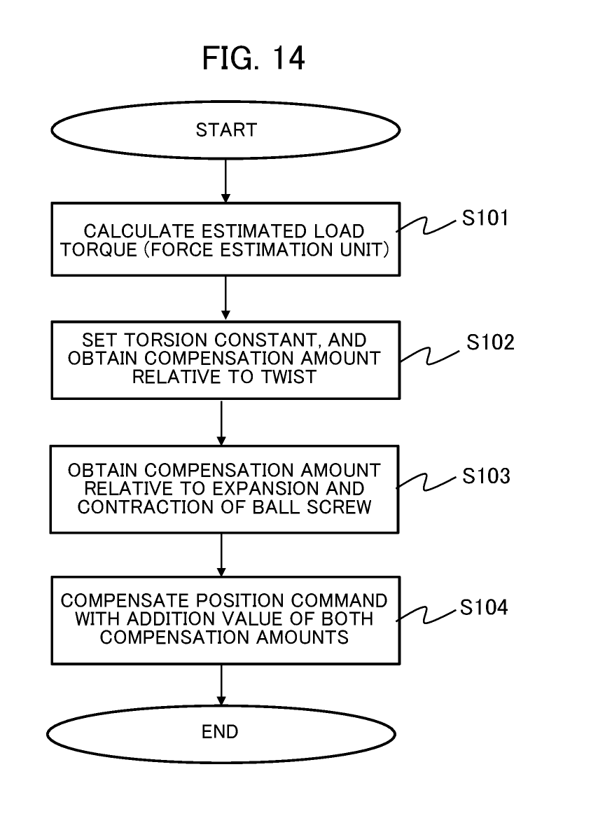

FIG. 14 is a flowchart showing the operation of the servomotor control device shown in FIG. 5. In Step S101, the force estimation part 302 calculates the estimated load torque (force estimated value). In Step S102, the torsion constant setting part 307 sets the torsion constant based on the estimated load torque (force estimated value), and the torsion constant multiplying part 303 obtains the compensation amount related to twist. In Step S103, the ball screw length multiplying part 304 and shape factor multiplying part 305 obtain the compensation amount related to the stretch/contraction of the ball screw. In Step S104, the adder 90 compensates the position command generated by the position command generation unit 10 with the addition value of the compensation amount related to twist and the compensation amount related to stretch/contraction of the ball screw. It should be noted that although Step S103 is arranged after Step S102 herein, the orders of Step S102 and Step S103 may be reversed so that Step S102 is arranged after Step S103.

### Second Embodiment

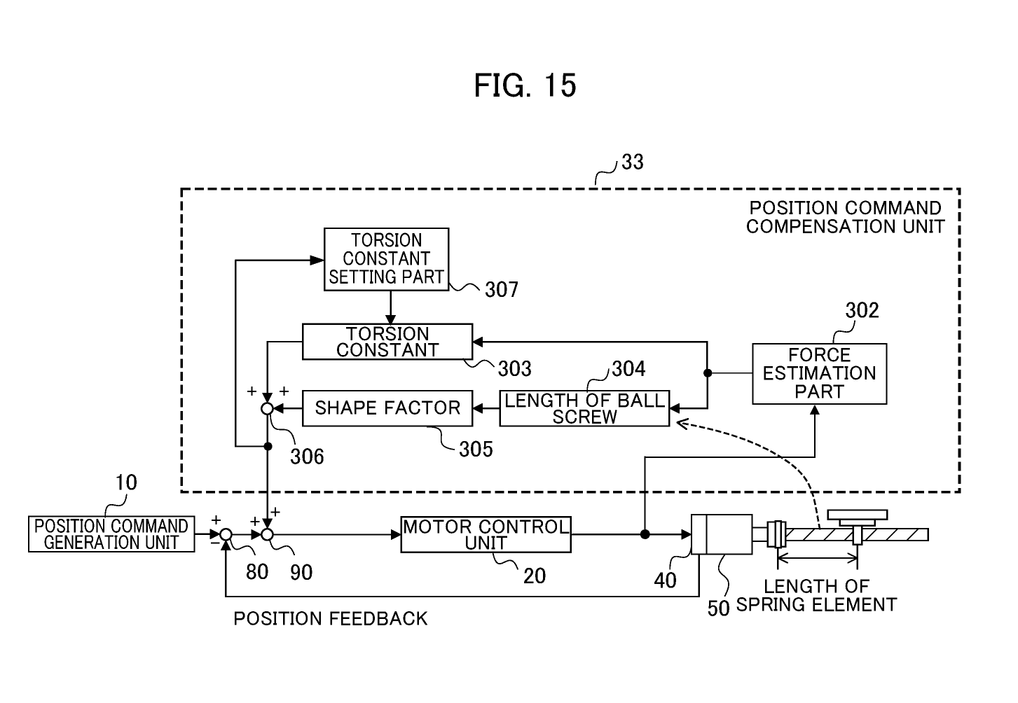

FIG. 15 is a block diagram showing the configuration of a servomotor control device serving as a second embodiment of the present invention. The position command compensation unit 31 shown in FIG. 5 is replaced by the position command compensation unit 33 in the present embodiment shown in FIG. 15. In the first embodiment shown in FIG. 5, although the torsion constant setting part 307 sets the torsion constant based on the estimated load torque (force estimated value), in the present embodiment, the torsion constant setting part 307 serving as a coefficient setting part sets the torsion constant based on the compensation value outputted from the adder 309.

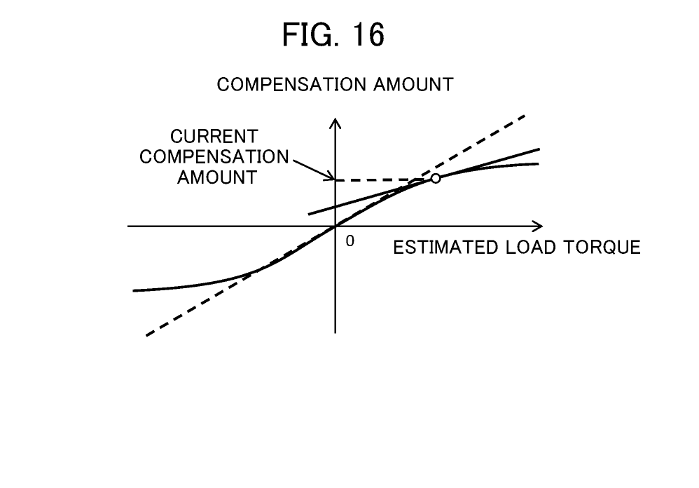

As shown in FIG. 16, if the change amount for the coefficient of the compensation amount relative to the compensation mount is decided in advance, since the estimated load torque and compensation amount correspond one-to-one, the torsion constant setting part 307 can change the coefficient of compensation (slope) according to the current value of the compensation amount. With the first embodiment, upon the absolute value for the estimated load torque (force estimated value) becoming greater than a predetermined value (upon becoming greater than point A), the compensation amount is continuously or discretely made smaller based on the estimated load torque, as shown in FIG. 9 and FIG. 10. In the present embodiment, upon the absolute value for the compensation value becoming greater than a predetermined value (upon becoming greater than point A), the compensation amount is continuously or discretely made smaller by an amount decided in advance, based on the compensation value.

The flowchart showing the operations of the servomotor control device of the present embodiment is the same except for the point of, in Step S102 of FIG. 14, the torsion constant setting part 307 sets the torsion constant based on the addition value of the compensation amount related to twist and the compensation amount related to stretch/contraction of the ball screw (compensation amount for compensating the position command value), and obtains the compensation amount related to twist.

Although embodiments of the present invention have been explained above, the entirety or part of the functions of the servomotor control device can be realized by hardware, software or a combination of these. Herein, being realized by software indicates the matter of being realized by a computer reading out and executing programs. In the case of constituting by hardware, a part or the entirety of the respective constitutional parts of the position command compensation units 31, 33 of the servomotor control device, the position command generation unit 10, and motor control unit 20 can be configured by integrated circuits (IC) such as LSI (Large Scale Integrated circuit), ASIC (Application Specific integrated Circuit), gate array and FPGA (Field Programmable Gate Array), for example.

In the case of being realized by software, a part of the entirety of the servomotor control device is configured by a computer which includes a CPU, and storage units such as a hard disk and ROM storing programs. Then, the information required in computation is stored in a second storage unit such as RAM, and by executing processing in accordance with the block diagram of FIGS. 5 and/or 15 and programs following the flowchart of FIG. 14, particularly in the case of realizing the position command compensation unit by software in accordance with programs following the flowchart of FIG. 14, a part or the entirety of operations of the servomotor control device can be executed by programs. The programs can be read into a storage unit such as a hard disk from a computer readable recording medium on which the programs are recorded. The computer readable recording medium includes tangible storage media. The computer readable recording medium includes non-transitory computer readable storage media. Examples of computer-readable recording media include magnetic media (for example, flexible disk, hard disk drive), magneto-optical recording media (for example, magneto-optical disk), CD-ROM (Read Only Memory), CD-R, CD-R/W, and semiconductor memory (for example, mask ROM, PROM (Programmable ROM), EPROM (Erasable PROM), flash ROM, RAM (random access memory)).

### EXPLANATION OF REFERENCE NUMERALS

10 position command generation unit

20 motor control unit

30, 31, 32, 33 position command compensation unit

40 encoder

50 servomotor

60 connection mechanism

70 table

301 compensation amount generation part

302 force estimation part

303 torsion constant multiplying part

304 ball screw length multiplying part

305 shape factor multiplying part

306 adder

307 torsion constant setting part

What is claimed is:

1. A servomotor control device, comprising:
a servomotor;
a driven body configured to be driven by the servomotor;
a connection mechanism configured to connect the servomotor and the driven body to transfer power of the servomotor to the driven body;
a position command generation unit configured to generate a position command value for the driven body;
a motor control unit configured to control the servomotor using the position command value;
a force estimation unit configured to estimate a force estimated value which is drive force acting on the driven body at a connecting part with the connection mechanism;
a compensation amount generation part configured to generate a compensation amount for compensating the position command value generated by the position command generation unit, using a product of the force estimated value and a coefficient indicating a physical constant; and
a coefficient setting unit configured to change the coefficient indicating the physical constant by the force estimated value or a magnitude of the compensation amount generated.

2. The servomotor control device according to claim 1,
wherein the compensation amount generation part sets, as the compensation amount, the sum of a product of the force estimated value and a first coefficient, and a product of the force estimated value, distance from the servomotor until the connecting part, and a second coefficient, and
wherein the product of the force estimated value and the first coefficient is a product of the force estimated value and a coefficient indicating a physical constant.

3. The servomotor control device according to claim 1, wherein the coefficient indicating the physical constant is continuously or discretely made smaller based on the force estimated value estimated by the force estimation unit, upon an absolute value for the force estimated value becoming large than a predetermined value.

4. The servomotor control device according to claim 1, wherein the coefficient indicating the physical constant is continuously or discretely made smaller based on the compensation amount generated by the compensation amount generation part, upon an absolute value for the compensation amount that was generated becoming greater than a predetermined value.

5. A servomotor control method for a servomotor control device including:
a servomotor;
a driven body configured to be driven by the servomotor; and
a connection mechanism configured to connect the servomotor and the driven body to transfer power of the servomotor to the driven body,
the method comprising the steps of:
generating a position command value for the driven body;
estimating a force estimated value which is a drive force acting on the driven body at a connecting part with the connection mechanism;
compensating the position command value by a compensation amount generated using a product of the force estimated value thus estimated and a coefficient indicating a physical constant; and
controlling the servomotor using the position command value thus compensated,
wherein the coefficient indicating the physical constant changes by the force estimated value or a magnitude of the compensation amount thus generated.

6. The servomotor control method according to claim 5, wherein the compensation value for compensating the position command value is the sum of a product of the force estimated value and a first coefficient, and a product of the force estimated value, distance from the servomotor until the connecting part, and a second coefficient, and
wherein the product of the force estimated value and first coefficient is a product of the force estimated value and a coefficient indicating a physical constant.

7. The servomotor control method according to claim 5, wherein the coefficient indicating the physical constant is continuously or discretely made smaller based on the estimated value thus estimated, upon an absolute value for the force estimated value becoming greater than a predetermined value.

8. The servomotor control method according to claim 5, wherein the coefficient indicating the physical constant is continuously or discretely made smaller based on the compensation amount thus generated, upon an absolute value for the compensation amount thus generated becoming greater than a predetermined value.

9. A non-transitory computer readable recording medium encoded with a program for servomotor control that causes a computer to execute servomotor control of a servomotor control device including: a servomotor;
a driven body configured to be driven by the servomotor; and
a connection mechanism configured to connect the servomotor and the driven body to transfer power of the servomotor to the driven body, the program causing the computer to execute processing of:
generating a position command value for the driven body;
estimating a force estimated value that is a drive force acting on the driven body at a connecting part with the connection mechanism;
compensating the position command value with a compensation amount generated using a product of the force estimated value thus estimated and a coefficient indicating a physical constant; and
controlling the servomotor using the position command value thus compensated,
wherein the coefficient indicating the physical constant changes by the force estimated value or magnitude of the compensation amount thus generated.
